(19) United States
(12) Patent Application Publication
(10) Pub. No.: US 2024/0275003 A1
(43) Pub. Date: Aug. 15, 2024

(54) BATTERY LID MODULE, BATTERY CELL ARRANGEMENT, AND BATTERY PACK

(71) Applicant: Turun Ammattikorkeakoulu Oy, Turku (FI)

(72) Inventor: Heikki Saariluoma, Tenhola (FI)

(73) Assignee: Turun Ammattikorkeakoulu Oy, Turku (FI)

(21) Appl. No.: 18/042,893

(22) PCT Filed: Apr. 1, 2022
(86) PCT No.: PCT/FI2022/050210

§ 371 Date: Feb. 24, 2023

(51) Int. Cl. H01M 50/627; H01M 50/15; H01M 50/209; H01M 50/342; H01M 50/507; H01M 50/55; H01M 50/691

(52) U.S. Cl. CPC H01M 50/627; H01M 50/15; H01M 50/209; H01M 50/3425; H01M 50/507; H01M 50/55; H01M 50/691

(57) ABSTRACT

The battery lid module includes a frame having a first end and a second end and a plurality of lids wherein each of the plurality of lids is formed by a body enclosing a flow channel and having at least one first lid opening and at least one second lid opening, at least one inlet and at least one outlet a first channel for fluidically coupling the at least one inlet and the at least one first lid opening of each of the plurality of lids. when the first channel, in use, is arranged along the longitudinal direction of the frame and a second channel for fluidically coupling the at least one outlet and the at least one second lid opening of each of the plurality of lids when the second channel, in use, is arranged along the longitudinal direction of the frame. Disclosed also a battery cell arrangement and a battery pack.

### TECHNICAL FIELD

The present disclosure relates to battery lid modules. The present disclosure also relates to battery cell arrangements comprising battery lid modules and battery cell housing modules. The present disclosure also relates to battery packs comprising battery cell arrangements and fluid delivery systems.

### BACKGROUND

In today's highly technological world, advanced machines, electrical or electronic equipment and devices are being used almost in every aspect of everyday life. Notably, batteries are not only integrated into the majority of equipment and devices used in our day-to-day life found in our home, workplace, and so forth but are also being used in complex machinery such as electric vehicles. Typically, the battery is a source of electric power consisting of one or more electrochemical cells connected in series and/or in parallel connection within a housing that converts the chemical energy into electrical energy. Moreover, the battery has external connections for powering electrical devices. Furthermore, due to progressive transformation, the batteries are now becoming more and more advanced. As a result, rechargeable batteries, such as lithium batteries, nickel-cadmium batteries, nickel-metal hydride batteries, lithium-ion batteries, and the like have emerged to accept, store, and release electricity on demand.

However, thermal regulation of batteries is a challenging problem which is not adequately solved by existing solutions. Firstly, the operation of the battery generates heat due to the losses as current flows through internal resistance of the battery resist the current flows. This happens when the battery is being charged or discharged. Moreover, overcharging of the battery and atmospheric conditions such as sunlight, humidity also contributes to overheating of the battery. Notably, the overheating of the battery may result in a swelling of battery, a charging issue, a short circuit that can further lead to fire hazards or explosions. Secondly, in some instances, the battery is required to be heated to bring it upto its required operating temperature. The existing solutions are unable to efficiently provide such functionality, leading to suboptimal battery usage and suboptimal battery life.

Therefore, in light of the foregoing discussion, there exists a need to overcome the aforementioned drawbacks of conventional batteries having poor thermal management.

### SUMMARY

The present disclosure seeks to provide a battery lid module. The present disclosure also seeks to provide a battery cell arrangement. The present disclosure also seeks to provide a battery pack.

In one aspect, an embodiment of the present disclosure provides a battery lid module comprising:
a frame having:
   a first end and a second end;
   a plurality of lids wherein each of the plurality of lids is formed by a body enclosing a flow channel and having at least one first lid opening and at least one second lid opening;
at least one inlet and at least one outlet;
a first channel for fluidically coupling the at least one inlet and the at least one first lid opening of each of the plurality of lids when the first channel, in use, is arranged along the longitudinal direction of the frame; and
a second channel for fluidically coupling the at least one outlet and the at least one second lid opening of each of the plurality of lids when the second channel, in use, is arranged along the longitudinal direction of the frame.

In another aspect, an embodiment of the present disclosure provides a battery cell arrangement comprising:
a battery lid module; and
a battery cell housing module having:
   at least one second partition defining a plurality of compartments in the battery cell housing module, wherein the battery lid module is adapted to be mounted on the battery cell housing module to cover an open end of the battery cell housing module such that one lid covers one compartment; and
   at least one fifth opening and at least one sixth opening, wherein when the battery lid module is mounted on the battery cell housing module, at least one inlet and at least one outlet of the battery lid module extend outwards from the at least one fifth opening and the at least one sixth opening, respectively.

In yet another aspect, an embodiment of the present disclosure provides a battery pack comprising:
a plurality of battery cell arrangements; and
a fluid delivery system for delivering a fluid from a fluid source to the plurality of battery cell arrangements and then from the plurality of battery cell arrangements to a fluid drain.

Embodiments of the present disclosure substantially eliminate or at least partially address the aforementioned problems in the prior art, and enables an effective, cost-efficient and reliable battery pack. The battery lid modules is easy to manufacture. Moreover, the battery pack have a compact design and arrangement of the first channel and the second channel provides the fluidic coupling to the battery lid module.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A is a perspective view of a battery lid module in accordance with an embodiment of the present disclosure;

FIG. 1B is a perspective view of a battery lid module shown in FIG. 1A without a first channel and a second channel therein in accordance with an embodiment of the present disclosure;

FIG. 1C is a cross-sectional view of a battery lid module shown in FIG. 1A viewed along line A-A in accordance with an embodiment of the present disclosure;

FIG. 1D is a cross-sectional view of a battery lid module shown in FIG. 1B viewed along line B-B in accordance with an embodiment of the present disclosure;

FIG. 1E is a cross-sectional view of a lid of a battery lid module as viewed from above;

FIG. 2 is a perspective view of a first channel and a second channel, in accordance with an embodiment of the present disclosure;

FIG. 3 is an exploded view of a battery cell arrangement, in accordance with an embodiment of the present disclosure;

FIG. 4 is a perspective view of a battery cell arrangement without a top cover, in accordance with an embodiment of the present disclosure; and

FIG. 5 is a schematic view of a battery pack, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a battery lid module comprising:
a frame having:
   a first end and a second end;
   a plurality of lids wherein each of the plurality of lids is formed by a body enclosing a flow channel and having at least one first lid opening and at least one second lid opening;
at least one inlet and at least one outlet;
a first channel for fluidically coupling the at least one inlet and the at least one first lid opening of each of the plurality of lids when the first channel, in use, is arranged along the longitudinal direction of the frame; and
a second channel for fluidically coupling the at least one outlet and the at least one second lid opening of each of the plurality of lids when the second channel, in use, is arranged along the longitudinal direction of the frame.

In another aspect, an embodiment of the present disclosure provides a battery cell arrangement comprising:
a battery lid module; and
a battery cell housing module having:
   at least one second partition defining a plurality of compartments in the battery cell housing module, wherein the battery lid module is adapted to be mounted on the battery cell housing module to cover an open end of the battery cell housing module such that one lid covers one compartment; and
   at least one fifth opening and at least one sixth opening, wherein when the battery lid module is mounted on the battery cell housing module, at least one inlet and at least one outlet of the battery lid module extend outwards from the at least one fifth opening and the at least one sixth opening, respectively.

In yet another aspect, an embodiment of the present disclosure provides a battery pack comprising:
a plurality of battery cell arrangements; and
a fluid delivery system for delivering a fluid from a fluid source to the plurality of battery cell arrangements and then from the plurality of battery cell arrangements to a fluid drain.

The present disclosure provides the aforementioned battery lid module, the aforementioned battery cell arrangement and the aforementioned battery pack. The battery lid module is configured to provide effective heat regulation in the battery cell arrangements within the battery pack. In this regard, the battery lid module comprises the first channel and the second channel to allow the fluid to flow therein to evenly distribute thermal energy (i.e., heat) throughout individual battery cells formed in the battery cell arrangement employing the battery lid module. Moreover, the fluid flow enables the plurality of battery cells can be cooled or heated more efficiently as compared to existing solutions for the same. Furthermore, the battery lid module, the battery cell arrangement and the battery pack have a compact design and been designed to prevent short circuit of the battery cells that may lead to fire hazards or explosions. In addition, the size of the first channel and second channel are designed to provide the fluidic coupling therethrough. Moreover, the terminal wiring are covered using the jellyroll bushing to prevent short circuit within the battery cell housing. It will be appreciated that the construction of the battery lid module is easy to manufacture and can be assembled with the battery cell arrangement and the battery cell housing with ease.

Throughout the present disclosure, the term “battery lid module” as used herein refers to modular element that serves as a lid designed and adapted to be mounted over the battery cell housing to cover the opening therein. The battery lid module accommodates the plurality of lids therein, wherein each lid serves as a covering of its corresponding battery cell. Said battery cell housing may be a separate part (i.e., separate from the battery lid module) that may enclose a plurality of battery cells therein. Moreover, the battery cell housing protects the plurality of battery cells from the outside temperature and environmental conditions. Optionally, the battery cell housing may be implemented to have a shape that is substantially a cube, a cuboid, a cylinder, or similar, corresponding to the shape of the battery lid module. Moreover, the battery lid module is dimensioned according to the dimensions of the battery cell housing so that the battery lid module abuts its side edges tightly against the side edges of the battery cell housing, whereby the battery lid module and the battery cell housing can be fastened to each other, for example by welding. Optionally, the battery lid module is manufactured using any one of 3D printing, casting (for example, precision casting), forming and the combination thereof. In addition, the battery lid module may be fabricated using any of the materials but not limited to aluminium, copper, stainless steel, alloys, plastics, rubbers, ceramics, 3D printing materials and the combination thereof.

Herein, the battery lid module comprises the frame having the first end and the second end opposite to the first end, the frame having the plurality of lids therebetween. Optionally, the first end and the second end of the frame may be chamfered to make it easier to weld and attach the battery lid module to the battery cell housing. Notably, the frame is made up of a single part. In other words, all constituent elements are formed as one integral unit to constitute the frame. Optionally, the frame may be made of small individual parts snugly fitted together or joined together (using, for example, an attachment means) to form the frame. Beneficially, the frame provides the structure and rigidity to the battery lid module. In some implementations, the plurality of lids are integrally formed in the battery lid module (for example, by printing technique) whereas in other implementations, the plurality of lids may be manufactured separately and then assembled into the battery lid module. Typically, the plurality of lids is configured to cover the plurality of battery cells. The plurality of lids are arranged one after other in a row adjacent to each other along a direction extending between the first end and the second end. Said direction is the longitudinal direction of the frame. Optionally, the plurality of lids are arranged parallel to the first end and the second end of the battery lid module.

Optionally, each of the plurality of lids is provided with a plurality of fins on a bottom side of the body. The plurality of fins increase a surface area of the bottom side of each of the plurality of lids, thereby enabling each lid to dissipate or absorb more heat therefrom. The term “flow channel” as used herein refers to the passage configured to flow the fluid, to transfer the heat to or from the plurality of battery cells. The flow channel is a pathway in a lid that allows the fluid to flow in the lid. Moreover, each of the plurality of lids is provided with the flow channel to flow the fluid therein. Optionally, the fluid may be flowed due to a pressure gradient. The flow channel comprises the at least one first lid opening and the at least one second lid opening arranged on opposite sides of each lid and located in the central region of the battery lid module, between the first terminals and the second terminals. In a given lid, its first lid opening and second lid opening are arranged in its central region. It will be appreciated that the at least one first lid opening and the at least one second lid opening are configured to receive the fluid from the first channel and the second channel respectively, to maintain a required operating temperature by removing the excess heat from the battery lid module. Optionally, the fluid may be a coolant. Optionally, the fluid also enables the heating of the battery cell (for example, during cold weather) to maintain the required operating temperature.

The term “at least one inlet” as used herein refers to port(s) configured to provide the fluid into the first channel and the term “at least one outlet” as used herein refers to port(s) configured to extract out the fluid from the second channel. The term “first channel” as used herein refers to a passage configured to flow the fluid into the at least one inlet whereas the term “second channel” refers to a passage configured to flow the fluid out of the at least one outlet. The fluid flows from the at least one inlet to the at least one outlet via the flow channels in the plurality of lids. Moreover, the first channel and the second channel are arranged parallel to each other and are orthogonal to the first end and the second end of the battery lid module. Additionally, the first channel and the second channel are arranged such that they extend continuously between the first end and second end of the battery lid module. Furthermore, the first channel provides the fluid to the flow channel of each of the plurality of lids while the second channel expels the fluid out of the flow channel of each of the plurality of lids. In addition, the first channel provides fluidic coupling between the at least one inlet and the at least one first lid opening of each of the plurality of lids and the second channel provides fluidic coupling between the at least one outlet and the at least one second opening of each of the plurality of lids.

It will be appreciated that the at least one inlet and the at least one outlet have an opening on at least one corresponding end at which they are provided, so as outside the battery lid module to deliver and extract the fluid respectively, therein. Optionally, the at least one inlet is provided at one or more of: the first end, the second end, the first channel, and wherein the at least one outlet is provided at one or more of: the first end, the second end, and the second channel. In this regard, the at least one inlet and the at least one outlet may be present at the first end, second end of the frame and/or upon the first channel and the second channel of the battery lid module. Optionally, the at least one inlet and the at least one outlet may comprise a plug to block the flow when not in use. As an example, one inlet and one outlet may be provided at each of the first end and the second end. As another example, one inlet may be provided at the first channel and one outlet may be provided at the second channel.

Optionally, the first channel comprises at least one first opening, a plurality of second openings, and a network of first conduits extending between the at least one first opening and the plurality of second openings, wherein when the first channel is in use, the first channel is fluidically coupled to a fluid source, the at least one first opening is aligned with the at least one inlet and the plurality of second openings are aligned with the at least one first lid opening of the plurality of lids. The term “fluid source” as used herein refers to a reservoir that supplies fluid to the first channel. The fluid may be supplied for thermal regulation of the battery cell arrangement including the battery lid module. Optionally, the fluid source may lie outside the battery lid module. In this regard, the at least one first opening is configured to provide the fluid within the first channel and the plurality of second openings are configured to deliver the received fluid into the each of the plurality of lids via first lid openings of the plurality of lids. Herein, the first channel is fluidically coupled to the fluid source and the fluid from the fluid source flows into the first channel. During use of the battery lid module, the at least one first opening is aligned with the at least one inlet to fill the fluid from the fluid source into the first channel, and then the fluid flows through the plurality of second openings into the flow channels of the plurality of lids.

Optionally, the second channel comprises at least one third opening, a plurality of fourth openings, and a network of second conduits extending between the at least one third opening and the plurality of fourth openings, wherein when the second channel is in use, the second channel is fluidically coupled to a fluid drain, the at least one third opening is aligned with the at least one outlet and the plurality of fourth openings are aligned with the at least one second lid opening of the plurality of lids. The term “fluid drain” as used herein refers to the reservoir that receives fluid from the second channel. The fluid may be supplied for thermal regulation of the battery cell arrangement including the battery lid module. Optionally, the fluid drain may lie outside the battery lid module. In this regard, the at least one third opening is configured to provide the fluid within the second channel and the plurality of fourth openings are configured to deliver the received fluid into the each of the plurality of lids via second lid openings of the plurality of lids. Herein, the second channel is fluidically coupled to the fluid drain and the fluid from the fluid drain to the fluid drain. During use of the battery lid module, the at least one third opening is aligned with the at least one outlet to drain the fluid from the second channel.

Optionally, the frame also has at least one first partition, wherein the at least one first partition has at least one first protrusion and at least one second protrusion, and wherein the at least one first protrusion and the at least one second protrusion are provided for securely attaching the first channel and the second channel with the frame. The term “protrusion” as used herein refers to a projection (for example, a ridge) or an obtrusion that extends longitudinally outwards from the at least one partition. In other words, a given protrusion extends along a length of a given partition. Moreover, the at least one protrusion and the at least second protrusion is configured to to support the first channel and the second channel respectively, within the frame. Furthermore, the the at least one first partition has at least one first protrusion and at least one second protrusion. Optionally, the at least one protrusion may be in a shape of parallelogram, such as, a trapezium, a rhombus and the like. Optionally, the height of the at least one first protrusion and the at least one second protrusion may be less than or equal to the height of the first channel and the second channel. Notably, the number of the at least one partition is equal to one less than the number of the plurality of lids.

Optionally, each of the plurality of lids is provided with a first terminal and a second terminal, and wherein the plurality of lids are arranged in a manner that different terminals of adjacent lids lie next to each other. The term “first terminal” and “second terminal” as used herein refers to an electrical contact or an electrode of a given battery cell. Typically, the first terminals and the second terminals of the plurality of battery cells are connected in a specific sequence. For example, if the five lids are arranged adjacent to each other then the one end may have a sequence of terminals such as a positive terminal, negative terminal, positive terminal, negative terminal, positive terminal and the second end may have a sequence of terminals such as a negative terminal, positive terminal, negative terminal, positive terminal, positive terminal. Optionally, the first terminal may be a positive terminal and the second terminal may be a negative terminal of the battery. Alternatively, optionally, the first terminal may be the negative terminal and the second terminal may be the positive terminal of the battery. Optionally, the battery lid module may be electrically conductive, with at least one of the terminals from the first terminal or the second terminal being integrated into the battery lid module and formed during the battery lid module manufacturing process. Also, at least one of the terminals from the first terminal or the second terminal is detachable and insulated from the battery lid module. Optionally, the electrode is made of a metal with high current conductivity.

Optionally, the frame also has two main terminals of the battery lid module. In this regard, the two main terminals serve as terminals of the battery cell arrangement including the battery lid module. Notably, the two main terminals have one positive main terminal and one negative main terminal. Optionally, the first terminal and the second terminal of each of the plurality of battery cells are connected to the main terminals through series connection. For example, a positive terminal of a first lid is connected to a negative terminal of its succeeding lid, and so on, a negative terminal of the first lid is connected to the positive main terminal, and a positive terminal of a last lid is connected to the negative main terminal. Optionally, the first terminal and the second terminal of each of the plurality of cells are connected to the main terminal through parallel connection. For example, all the positive terminals of each of the plurality of lids are connected to the positive main terminal and all the negative terminals of each of the plurality of lids are connected to the negative main terminal. It will be appreciated that the load can be connected across the said main terminals, to provide power to the load.

Optionally, a plurality of busbars are employed for electrically coupling terminals of the plurality of lids. The busbar is a rigid piece of metal in the form of a metallic strip, or a bar that is designed to electrically connect two terminals of two lids. Optionally, a given busbar electrically connects a first terminal of a given lid to a second terminal of another lid. Typically, the plurality of busbars are arranged to distribute large amounts of current through the battery lid module with greater ease than if such busbars were not used. Optionally, the plurality of busbars are fabricated from a metal material (for example, such as copper, brass or aluminium, and the like) having a high electrical conductivity. Beneficially, each of the plurality of busbars has a large cross-sectional area. In addition, the large surface area of the plurality of busbars dissipates or absorbs heat more efficiently over its entire length.

Optionally, each of the plurality of lids is provided with a fill port, and wherein a given channel comprises at least one through-hole that is in fluid communication with at least one fill port of at least one lid, wherein the at least one through-hole provides access to the at least one fill port. Moreover, the at least one fill port are arranged alternatively within the first channel and the second channel respectively. Furthermore, the number of fill port in a first channel is half the number of lids. For example, if the the battery lid module having the five lids then the first channel or the second channel may have three fill ports and the second channel or the first channel may have two fill ports.

Optionally, each of the plurality of lids is provided with a pressure vent with a predetermined breaking region of reduced thickness, the pressure vent being arranged on an upper side of the body, and wherein the first channel and the second channel are arranged on the upper side of the body in a manner that the pressure vent is unobstructed. The term “pressure vent” as used herein refers to a pressure release valve that allows the gases produced during the operation to vent into the atmosphere to avoid rupture of the battery cell housing. The pressure vent is provided on an upper side of the body of the plurality of lids, is arranged between the one at least first lid opening and the at least one second lid opening, and is optionally fabricated of the same material as the battery lid module. The pressure vent has a predetermined breaking region of a reduced material thickness. The material thickness in the breaking region is preferably less than in the surrounding region, thereby allowing the breaking region to rupture at a predetermined pressure threshold with the increase of internal pressure of the battery cell housing to be covered by the battery lid module.

The present disclosure also relates to the battery cell arrangement as described above. Various embodiments and variants disclosed above apply mutatis mutandis to the battery cell arrangement.

The term “battery cell arrangement” as used herein refers to an arrangement of a group of battery cells arranged in series or parallel connections. The group of battery cells are provided using the battery lid module and the battery cell housing. Notably, the battery cell arrangement has a higher voltage when the group of battery cells are connected in a series connection than when the group of battery cells are connected in a parallel connection. Furthermore, the battery cell arrangement has a higher current when the group of battery cells are connected in the parallel connection than when the group of battery cells are connected in the series connection.

The term “battery cell housing module” as used herein refers to a casing configured to enclose the group of battery cells of the battery cell arrangement. It will be appreciated that the battery cell housing comprises the at least one second partition to form the plurality of compartments. For example, the first partition of the at least one second partition forms two compartments, in the same way, second partition of the at least one second partition forms three compartments, and so on. Optionally, a height of the at least one second partition is less than a height of the battery cell housing module. Moreover, the battery lid module is mounted on the battery cell housing to cover the plurality of compartments. Notably, a bottom side of the battery lid module covers the open end of the battery cell housing module when in use. Furthermore, the battery cell housing module having the at least one fifth opening and at least one sixth opening on either side of the battery cell housing is configured to provide a space for the at least one inlet and at least one outlet respectively, of the battery lid module to extend outwards from the battery cell housing module when the battery lid module in use covers the battery cell housing module. Notably, the shape of the the at least one fifth opening and at least one sixth opening corresponds to the at least one inlet and at least one outlet respectively, of the battery lid module. For example, the shape of the at least one fifth opening and at least one sixth opening may have a circular shape, corresponds to the at least one inlet and at least one outlet.

Optionally, each of the plurality of compartments is dimensioned to accommodate therein at least: terminal wiring extending from a first terminal and a second terminal of a corresponding lid, bushings covering the terminal wiring, an electrolyte. It will be appreciated that the plurality of compartments is dimensioned to accommodate the plurality of lids to install therein, such that, the plurality of lid tightly fits within each of the plurality of compartments of the battery cell housing. Beneficially, this allows the battery lid module to attach to the battery cell housing easier, for example by means of welding. The term “terminal wiring” as used herein refers to the wiring configured to connect the at least two terminals of the plurality of battery cells of the battery cell arrangement. The terminal wiring extends from terminals of the plurality of lids, is covered by the bushings and is in contact with the electrolytes in the each of the plurality of compartments. Beneficially, the size of the compartment must be large enough to accommodate the aforesaid components and is selected to be such that the accommodation is easy and has a positive tolerance. Optionally, the bushing may be a jellyroll bushing. In this regards, the jellyroll bushing is implemented as an insulator that allows the terminal wiring to pass safely therethrough to avoid any contact with the other terminal wiring. Beneficially, the jellyroll bushing prevents any short circuit.

Optionally, the battery cell arrangement further comprises a cover plate that in use, is attached to the battery lid module to cover the battery lid module. The term “cover plate” as used herein refers to the covering configured to cover the battery lid module from a top side of the battery lid module to prevent the battery lid module in direct contact with the environment. Moreover, use of the cover plate prevents electrical shocks and short circuits. Optionally, the cover plate is made of an insulating material. The insulating material may, for example, be a material such as plastic, rubber, and the like. Optionally, a frame of the battery lid module has two main terminals of the battery lid module and the cover plate has two through-recesses that are adapted to allow the two main terminals to extend outwards from the cover plate when the cover plate is in use. Moreover, the position of the two through-recesses on the cover plate corresponds to the position of the main terminals on the battery lid module. In this regard, the two through-recesses are adapted to allow the two main terminals to extend outwards from the cover plate for connecting the battery with the load or for charging. Additionally, the two through-recesses provides the access to the main terminal without opening the battery cell arrangement. The two through-recesses have a suitable shape and a diameter large enough to allow the two main terminals to extend outwards.

The present disclosure also relates to the battery pack as described above. Various embodiments and variants disclosed above apply mutatis mutandis to the battery pack.

The term “battery pack” as used herein refers to a set of battery cell arrangements having the battery lid module enclosed within the battery cell housing module to provide electricity. Notably, the battery pack is a reachargeble battery to provide portable electricity for powering electrical devices. The battery pack also comprises the fluid delivery system in addition to the battery cell arrangements. The fluid delivery system provides stable flow rates of the fluid to flow to and from the battery cell arrangements. Optionally, the fluid delivery system also provides different flow rates (over a given range of flow rates) when multiple fluids are being concurrently delivered to the battery cell arrangements. Notably, the fluid delivery system includes at least two reservoirs. Optionally, the fluid delivery is controlled by adjusting the pressure of the fluid delivery system. It will be appreciated that fluid exchanged between the fluid delivery system and the battery cell arrangements is responsible for maintaining the operating temperature within the battery cell arrangement. In other words, the fluid is used for thermal management of the battery cell arrangements by either using the fluid for cooling the battery cell arrangements or using the fluid for heating the battery cell arrangements, as per requirement. As an example, the fluid carries the heat produced during the operation of the battery cell from one reservoir to another to provide cooling thereof.

For example, the battery pack having 14 battery cell arrangements arranged in an array of 7*2 such the the length of such battery pack may be 1000 mm and width may be 500 mm connected to the fluid delivery module. Said arranged is configured to provide an output voltage of 322V. In this regard, each battery cell arrangements produces 23V, when two such battery pack arranged then the output voltage increase s to the 644V.

Optionally, the fluid delivery system is implemented as:
a fluid supply channel that fluidically couples the fluid source with inlets of a plurality of battery lid modules of the plurality of battery cell arrangements; and
a fluid expulsion channel that fluidically coupled the fluid drain with outlets of a plurality of battery lid modules of the plurality of battery cell arrangements.

In this regard, the fluid supply channel is fluidically coupled with the inlets of the plurality of battery lid modules to deliver the fluid therein, such fluid being provided by the fluid source. It will be appreciated that the fluid supply channel comprises the fluid supply channel inlet to receive fluid from the fluid source and the fluid supply channel outlet aligned with the at least one inlet of the battery lid module to provide the path for the fluid to flow from the fluid source to the battery lid module. Moreover, the fluid expulsion channel is fluidically coupled with the outlets of the plurality of battery lid modules for removal of the fluid from therein, such fluid being collected upon removal at the fluid drain. It will be appreciated that the fluid expulsion channel comprises the the fluid expulsion channel inlet to receive fluid from the at least one outlet of the battery lid module and the the fluid expulsion channel outlet to provide the path for the fluid to flow from the fluid expulsion channel to the fluid source.

Optionally, the fluid delivery system is implemented as a plurality of hoses, the plurality of hoses comprising:
a first set of hoses, wherein a given hose of the first set fluidically couples an inlet of a given battery lid module of the plurality of battery cell arrangements with any of: an inlet of another battery lid module of the plurality of battery cell arrangements, the fluid source; and
a second set of hoses, wherein a given hose of the second set fluidically couples an outlet of the given battery lid module of the plurality of battery cell arrangements with any of: an outlet of another battery lid module of the plurality of battery cell arrangements, the fluid drain.

In this regard, the fluid flows with the hoses arranged in the battery pack to exchange the fluid between the fluid source, the fluid drain and the plurality of battery cell arrangements. The first set of hoses is fluidically coupled with the inlets of the plurality of battery lid modules and the fluid source such that the inlets of the plurality of battery lid modules are connected in a serial manner with the fluid source. As an example, an inlet of a first battery lid module is connected via hoses to the fluid source and an inlet of a second battery lid module, the inlet of the second battery lid module is also connected via a hose to an inlet of a third battery lid module, and so on such that an inlet of a second-last battery lid module is also connected via a hose to an inlet of a last battery lid module in the battery pack. In this way, the fluid flows from the fluid source to the first battery lid module and so on until it reaches the last battery lid module. The second set of hoses is fluidically coupled with the at least one lid outlet of the plurality of battery lid modules such that the outlet of each of the plurality of battery lid modules is connected together. As an example, an outlet of a first battery lid module is connected via hoses to the fluid drain and an outlet of a second battery lid module, the outlet of the second battery lid module is also connected via a hose to an outlet of a third battery lid module, and so on such that an outlet of a second-last battery lid module is also connected via a hose to an outlet of a last battery lid module in the battery pack. In this way, the fluid flows from the first battery lid module and so on to the fluid drain. Typically, the different set of hoses are configured to carry the fluid to avoid unwanted heat exchange and contamination.

### DETAILED DESCRIPTION OF THE DRAWINGS

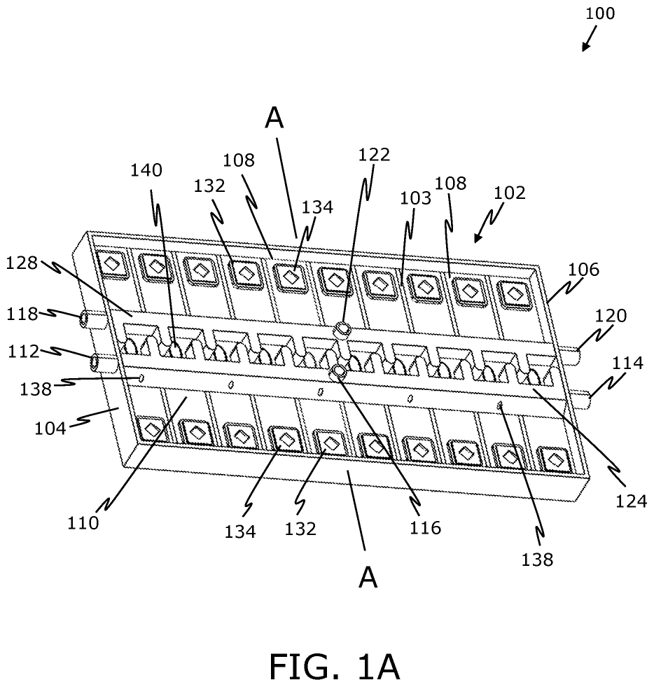

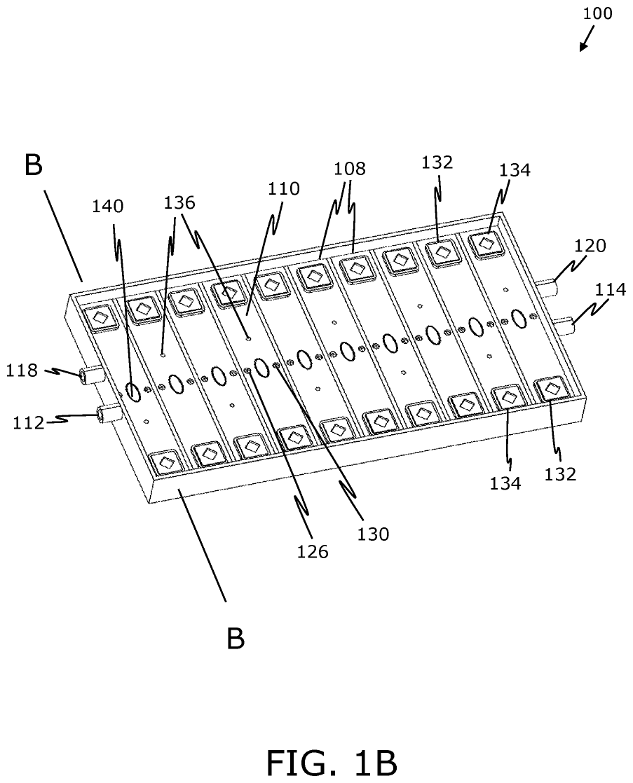

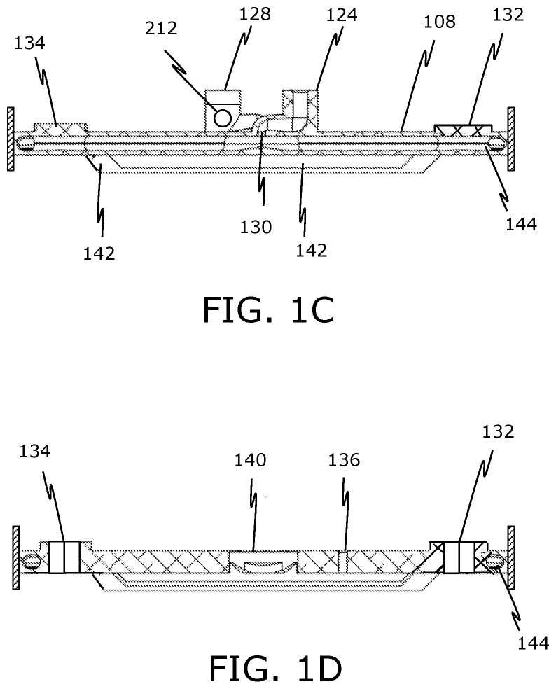

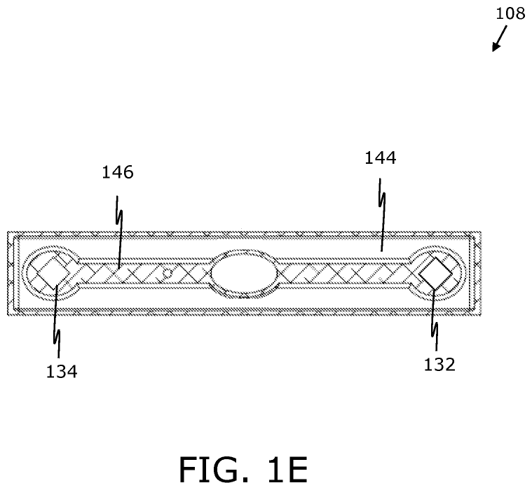

Referring to FIGS. 1A and 1B, illustrated are a top perspective view and a bottom perspective view of a battery lid module, respectively, in accordance with an embodiment of the present disclosure. As shown in FIG. 1A, a battery lid module 100 comprising a frame 102 having a first end 104, a second end 106 and a plurality of lids 108 wherein each of the plurality of lids is formed by a body 110 enclosing a flow channel 144 (shown in FIG. 1C). The battery lid module 100 further comprises at least one inlet 112, 114, 116 and at least one outlet 118, 120, 122. The battery lid module 100 further comprises a first channel 124 for fluidically coupling the at least one inlet 112, 114, 116 and the at least one first lid opening 126 (shown in FIG. 1B) of each of the plurality of lids 108 when the first channel 124, in use, is arranged along the longitudinal direction of the frame 102 and a second channel 128 for fluidically coupling the at least one outlet 118, 120, 122 and the at least one second lid opening 130 (shown in FIG. 1B) of each of the plurality of lids 108 when the second channel 128, in use, is arranged along the longitudinal direction of the frame 102. Between each of the plurality of lids 108 there is optionally be a partition or a groove 103 extending longitudinally between the plurality of lids, as shown in FIG. 1A. Moreover, each of the plurality of lids 108 is provided with a first terminal 132 and a second terminal 134 and wherein the plurality of lids 108 are arranged in a manner that different terminals of adjacent lids lie next to each other. Furthermore, the plurality of lids 108 is provided with a fill port 136 (shown in FIG. 1B and FIG. 1D), and wherein the first channel 124 and the second channel 128 comprises at least one through-hole 138 that is in fluid communication with at least one fill port 136 of at least one lid, wherein the at least one through-hole 138 provides access to the at least one fill port 136. As shown in FIG. 1B, the plurality of lids 108 having at least one first lid opening 126 and at least one second lid opening 130. The plurality of lids 108 is provided with a pressure vent 140 with a predetermined breaking region of reduced thickness, the pressure vent 140 being arranged on an upper side of the body 110, and wherein the first channel 124 and the second channel 128 are arranged on the upper side of the body 110 in a manner that the pressure vent 140 is unobstructed.

Referring to FIG. 1C, illustrated is a cross-sectional view of of a battery lid module shown in FIG. 1A viewed along line A-A. As shown in FIG. 1C, each of the plurality of lids 108 of the battery lid module has a body formed of an upper side and a lower side, and a plurality of sides that extend upwardly between the upper side and the lower side, enclosing a flow channel 144 therebetween. The upwardly extending sides between the lids of the battery lid module connect the adjacent bodies of the battery lid module to each other and divide the fluid flow to flow channels 144. The battery lid module, on its lower side, optionally has a plurality of parallel and spaced-apart heat transfer fins 142, which may be provided for each of the plurality of lids, which fins extend along the surface of the lower side between the opposite terminal ends to improve the heat distribution and transfer between the sides of the lid. The fins 142 are arranged in the central region in each of the plurality of the lids of the battery lid module and spaced from the side edges.

FIG. 1E illustrates a cross-sectional view of a lid 108 of the battery lid module as viewed from above. Each of the plurality of lids may be implemented in the battery lid module in the same manner. In FIG. 1E, the flow channel 144 extends within a plurality of side edges within the body of the lid 108 and is divided into two channel halves by a partition 146 arranged in the central region of the lid 108 and shaped so that the flow channel has a variable width along the length of the lid between the opposite terminals 132, 134. The flow channel 144 is formed to surround opposite terminals 132, 134 and configured to separate the terminals electrically and hermetically from the flow channel 144.

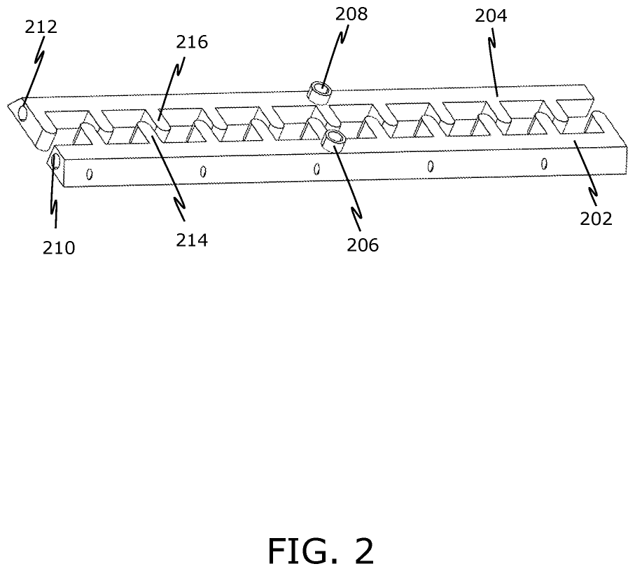

Referring to FIG. 2, illustrated is a perspective view of a first channel and a second channel, in accordance with an embodiment of the present disclosure. As shown, the first channel 202 and the second channel 204 having at least one inlet 206 and the at least one outlet 208 respectively. Moreover, the first channel 202 comprises at least one first opening 210 fluidically connected to the at least one inlet and the second channel 204 comprises at least one third opening 212 fluidically connected to the at least one outlet. Moreover, the first channel 202 comprises a network of first conduits 214 extending between the at least one first opening 210 and the plurality of second openings and the second channel 204 comprises a network of second conduits 216 extending between the at least one third opening 212 and the plurality of fourth openings.

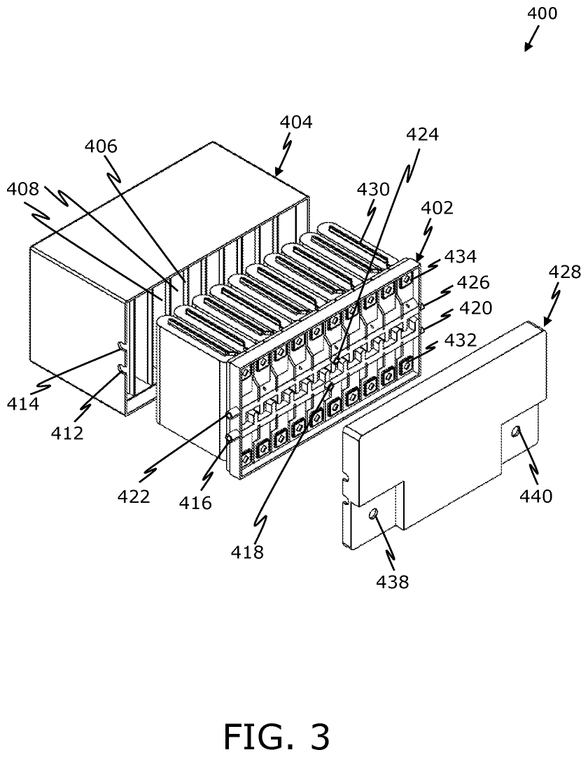

Referring to FIG. 3, illustrated is an exploded view of a battery cell arrangement 400, in accordance with an embodiment of the present disclosure. The battery cell arrangement 400 comprising a battery lid module 402 and a battery cell housing module 404 having at least one second partition 406 defining a plurality of compartments 408 in the battery cell housing module 404, wherein the battery lid module 402 is adapted to be mounted on the battery cell housing module 404 to cover an open end 410 of the battery cell housing module 404 such that one lid of battery lid module 406 covers one compartment from plurality of compartments 408 and at least one fifth opening 412 and at least one sixth opening 414, wherein when the battery lid module 402 is mounted on the battery cell housing module 404, at least one inlet 416, 418, 420 and at least one outlet 422, 424, 426 of the battery lid module 402 extend outwards from the at least one fifth opening 412 and the at least one sixth opening 414, respectively. The battery cell arrangement 400 further comprising a cover plate 428 that in use, is attached to the battery lid module 402 to cover the battery lid module 402. In addition, the plurality of compartments 408 is dimensioned to accommodate the terminal wiring 430 extending from a first terminal 432 and a second terminal 434 of a corresponding lid, covering of the terminal wiring, an electrolyte. Furthermore, the cover plate 428 has two through-recesses 438, 440 that are adapted to allow the two main terminals to extend outwards from the cover plate 428 when the cover plate 428 is in use.

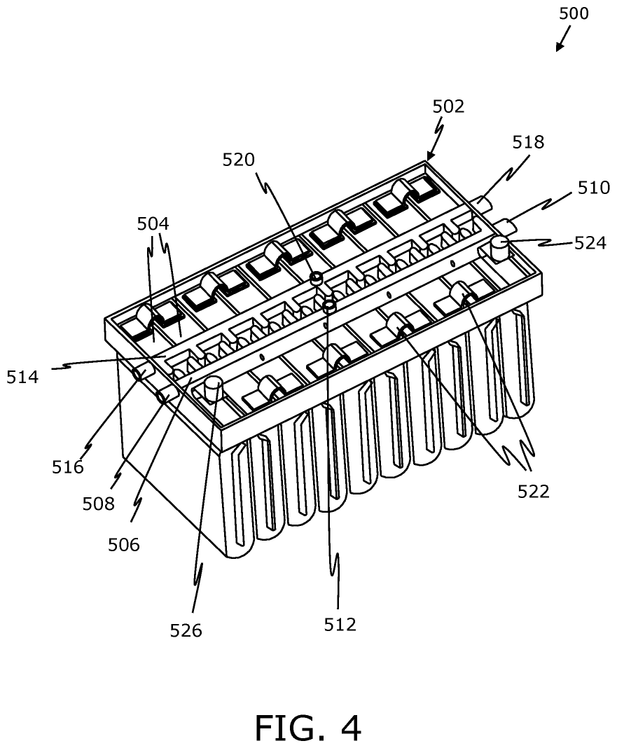

Referring to FIG. 4, illustrated is a perspective view of a battery cell arrangement 500 without a top cover, in accordance with an embodiment of the present disclosure. As shown, the battery cell arrangement 500 comprising the battery lid module 502 having the plurality of lids 504, the first channel 506 for fluidically coupling the at least one inlet 508, 510, 512 and the at least one first opening (not shown) of each of the plurality of lids and a second channel 514 for fluidically coupling the at least one outlet 516, 518, 520 and the at least one second opening (not shown) of each of the plurality of lid 504. The battery lid module 502 also comprises a plurality of busbars 522 are employed for electrically coupling terminals of the plurality of lids 504. The battery cell arrangement further comprises two main terminals 524, 526 of the battery lid module.

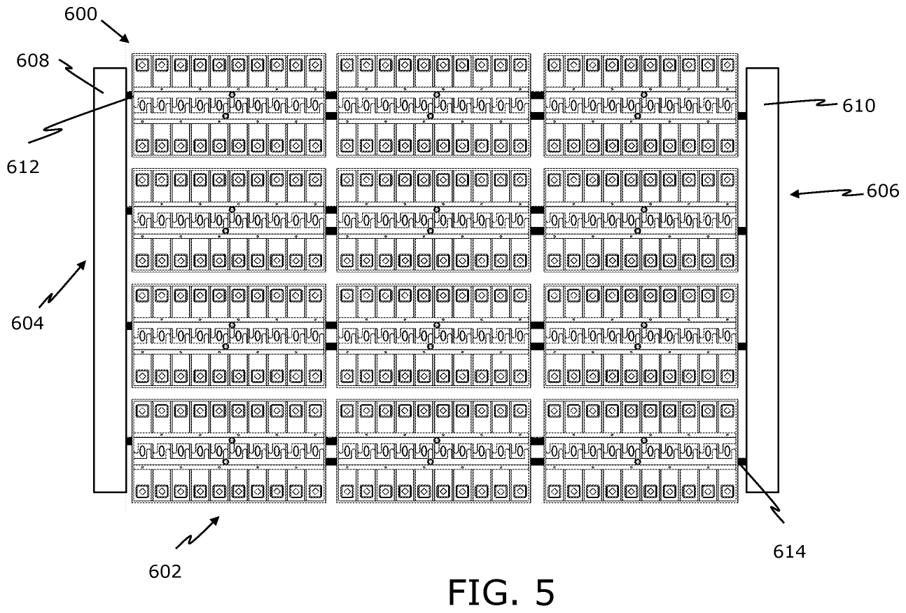

Referring to FIG. 5, illustrated is a schematic view of a battery pack 600, in accordance with an embodiment of the present disclosure. A battery pack 600 comprising a plurality of battery cell arrangements 602 and a fluid delivery system for delivering a fluid from a fluid source 604 to the plurality of battery cell arrangements 602 and then from the plurality of battery cell arrangements 602 to a fluid drain 606. The fluid delivery system is implemented as a fluid supply channel 608 that fluidically couples the fluid source 604 with inlets of a plurality of battery lid modules of the plurality of battery cell arrangements 602 and a fluid expulsion channel 610 that fluidically couples the fluid drain 606 with outlets of a plurality of battery lid modules of the plurality of battery cell arrangements 602. The fluid delivery system also comprises a first set of hoses 612 and a second set of hoses 614. The first set of hoses 612 is fluidically coupled with the inlets of the plurality of battery lid modules and the fluid source 604. The second set of hoses 614 is fluidically coupled with the at least one lid outlet of the plurality of battery lid modules and the fluid drain 606.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. The battery lid module comprising:
a frame having:
a first end and a second end;
a plurality of lids wherein each of the plurality of lids is formed by a body enclosing a flow channel and having at least one first lid opening and at least one second lid opening;
at least one inlet and at least one outlet;
a first channel for fluidically coupling the at least one inlet and the at least one first lid opening of each of the plurality of lids when the first channel, in use, is arranged along the longitudinal direction of the frame; and
a second channel for fluidically coupling the at least one outlet and the at least one second lid opening of each of the plurality of lids when the second channel, in use, is arranged along the longitudinal direction of the frame.

2. The battery lid module according to claim 1, wherein the at least one inlet is provided at one or more of: the first end, the second end, the first channel, and wherein at least one outlet is provided at one or more of: the first end, the second end, and the second channel.

3. The battery lid module according to claim 1, wherein the first channel comprises at least one first opening, a plurality of second openings, and a network of first conduits extending between the at least one first opening and the plurality of second openings,
wherein when the first channel is in use, the first channel is fluidically coupled to a fluid source, the at least one first opening is aligned with the at least one inlet and the plurality of second openings are aligned with the at least one first lid opening of the plurality of lids.

4. The battery lid module according to claim 1, wherein the second channel comprises at least one third opening, a plurality of fourth openings, and a network of second conduits extending between the at least one third opening and the plurality of fourth openings,
wherein when the second channel is in use, the second channel is fluidically coupled to a fluid drain, the at least one third opening is aligned with the at least one outlet and the plurality of fourth openings are aligned with the at least one second lid opening of the plurality of lids.

5. The battery lid module according to claim 1, wherein each of the plurality of lids is provided with a first terminal and a second terminal, and wherein the plurality of lids are arranged in a manner that different terminals of adjacent lids lie next to each other.

6. The battery lid module according to any claim 1, wherein a plurality of busbars are employed for electrically coupling terminals of the plurality of lids.

7. The battery lid module according to claim 1, wherein each of the plurality of lids is provided with a fill port, and wherein a given channel comprises at least one through-hole that is in fluid communication with at least one fill port of at least one lid, wherein the at least one through-hole provides access to the at least one fill port.

8. The battery lid module according to claim 1, wherein each of the plurality of lids is provided with a pressure vent with a predetermined breaking region of reduced thickness, the pressure vent being arranged on an upper side of the body, and wherein the first channel and the second channel are arranged on the upper side of the body in a manner that the pressure vent is unobstructed.

9. The battery lid module according to claim 1, wherein the frame also has two main terminals of the battery lid module.

10. The battery cell arrangement comprising:
a battery lid module according to claim 1; and
a battery cell housing module having:
at least one second partition defining a plurality of compartments in the battery cell housing module, wherein the battery lid module is adapted to be mounted on the battery cell housing module to cover an open end of the battery cell housing module such that one lid covers one compartment; and
at least one fifth opening and at least one sixth opening, wherein when the battery lid module is mounted on the battery cell housing module, at least one inlet and at least one outlet of the battery lid module extend outwards from the at least one fifth opening and the at least one sixth opening, respectively.

11. The battery cell arrangement of claim 10, further comprising a cover plate that in use, is attached to the battery lid module to cover the battery lid module.

12. The battery cell arrangement of claim 11, wherein a frame of the battery lid module has two main terminals of the battery lid module and the cover plate has two through-recesses that are adapted to allow the two main terminals to extend outwards from the cover plate when the cover plate is in use.

13. The battery cell arrangement of claim 10, wherein each of the plurality of compartments is dimensioned to accommodate therein at least: terminal wiring extending from a first terminal and a second terminal of a corresponding lid, covering of the terminal wiring, an electrolyte.

14. The battery pack comprising:
a plurality of battery cell arrangements according to claim 10; and
a fluid delivery system for delivering a fluid from a fluid source to the plurality of battery cell arrangements and then from the plurality of battery cell arrangements to a fluid drain.

15. The battery pack according to claim 14, wherein the fluid delivery system is implemented as:
a fluid supply channel that fluidically couples the fluid source with inlets of a plurality of battery lid modules of the plurality of battery cell arrangements; and
a fluid expulsion channel that fluidically coupled the fluid drain with outlets of a plurality of battery lid modules of the plurality of battery cell arrangements.

16. The battery pack according to claim 14, wherein the fluid delivery system is implemented as a plurality of hoses, the plurality of hoses comprising:
a first set of hoses, wherein a given hose of the first set fluidically couples an inlet of a given battery lid module of the plurality of battery cell arrangements with any of: an inlet of another battery lid module of the plurality of battery cell arrangements, the fluid source; and
a second set of hoses, wherein a given hose of the second set fluidically couples an outlet of the given battery lid module of the plurality of battery cell arrangements with any of: an outlet of another battery lid module of the plurality of battery cell arrangements, the fluid drain.
